(19) United States
(12) Patent Application Publication
(10) Pub. No.: US 2009/0123677 A1
(43) Pub. Date: May 14, 2009

(54) Composite dough can recyclable as an all-paper product

(75) Inventor: Veronique Sins, Grimbergen (BE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/985,169

(22) Filed: Nov. 13, 2007

(51) Int. Cl. B29D 22/00

(52) U.S. Cl. 428/34.2

(57) ABSTRACT

A refrigerated dough container that has less than 5% non-paper material by weight such that the container qualifies as being a recyclable paper article. The container includes a paperboard body ply and a liner ply adhered to the inner surface of the body ply. The liner ply consists of a paper layer having an outer surface adhered to the inner surface of the container body, and at least one non-paper layer imparting moisture/gas barrier and sealing characteristics to the liner. The total weight of the non-paper layer(s) does not exceed 5% of the combined body ply and liner ply weight. The non-paper layers can include a metallized film or thin foil as a barrier layer and a polyolefin or sealing varnish as a sealant layer. Alternatively, a single non-paper layer, namely a PVDC layer, can be extrusion-coated onto the paper layer.

### BACKGROUND OF THE INVENTION

The invention relates to composite cans for containing refrigerated dough, consisting of a paperboard body and an impervious liner having both paper and non-paper components.

A conventional dough can has a paperboard body and a liner that includes non-paper materials such as polymer film and aluminum foil. Typically, in a conventional dough can, about 8% to 10% of the can's total weight consists of the non-paper materials. In some jurisdictions such as Europe, there are increasingly stringent regulations on packaging, whereby packaging that has more than 5% non-paper material by weight is not considered to be recyclable paper and thus is taxed more heavily than packaging that has less than 5% non-paper material.

It was desired to develop a dough can that meets all of the usual requirements for dough cans (i.e., adequate barrier performance against moisture and gas migration through the can wall, sufficient strength to maintain integrity of the can and resist the internal pressure buildup as the dough expands in the can, and ease and safety of opening of the can), while containing less than 5% by weight non-paper material. This required the non-paper material content to be reduced by an amount equal to 3% of the total can weight. While 3% does not appear to be a significant amount, it represents a large percentage of the non-paper material; more specifically, 3% out of the current 8% is approximately 38% by which the weight of the non-paper material would have to be reduced, assuming the same paperboard body were used. Accordingly, achieving the less than 5% non-paper material objective proved to be a challenge.

### BRIEF SUMMARY OF THE DISCLOSURE

The present disclosure relates to a refrigerated dough container that has less than 5% non-paper material by weight. Generally, the container includes a paperboard body ply wrapped helically about an axis to form a tubular container body, with opposite edges of the paperboard body ply being abutted but unattached so as to form a separable joint that extends helically about the container body. The paperboard body ply has a weight of BP. The container further includes a liner adhered to the inner surface of the container body, the liner being formed by a liner ply wound helically about the axis with opposite edges of the liner ply being overlapped and attached to each other. The liner ply consists of a paper layer having an outer surface adhered to the inner surface of the container body, the paper layer having a weight of PL, and at least one non-paper layer imparting moisture/gas barrier and sealing characteristics to the liner. The non-paper layer(s) have a total weight of NP. The weights of the paperboard body ply and the paper and non-paper layers of the liner are selected such that (BP+PL) divided by (BP+PL+NP) is at least 0.95 (i.e., the weight of the paper content of the body ply and liner is at least 95% of the total body ply plus liner weight).

In one embodiment, the paperboard body ply is a single layer of paperboard having a basis weight of 450 to 500 grams per square meter, the paper layer of the liner has a basis weight of 30 to 45 grams per square meter, and the non-paper layer(s) of the liner has/have a total basis weight of 12 to 35 grams per square meter.

The present disclosure describes a number of liner structures that can enable the less than 5% non-paper material objective to be met. For example, in one approach, the non-paper layer(s) of the liner consists of an adhesive layer applied to an inner surface of the paper layer and having a weight of AL, a barrier layer having an outer surface adhered to the adhesive layer and having a weight of BL, and a sealant layer adhered to an inner surface of the barrier layer and having a weight of SL. The weights of the paperboard body ply and the layers of the liner are selected such that (BP+PL) divided by (BP+PL+AL+BL+SL) is at least 0.95.

In one embodiment, the barrier layer is a polymer film, one surface of which is metallized with a vacuum-deposited coating of a substantially pure metal in non-oxide form, the barrier layer having a thickness of about 10 to 12 μm. In one implementation of this embodiment, the polymer film of the barrier layer is oriented polypropylene. The sealant layer is a polyolefin film (e.g., polyethylene) having a thickness of about 10 to 15 μm. The paper layer of the liner in this implementation has a basis weight of 30 to 35 grams per square meter.

In another implementation of the approach employing a metallized film barrier layer, the polymer film of the barrier layer is polyethylene terephthalate. The sealant layer is a sealing varnish applied to the barrier layer at a basis weight of 1.0 to 2.0 grams per square meter.

In accordance with another approach, the barrier layer is a layer of metal foil having a thickness of 5 to 10 μm, and the sealant layer is a sealing varnish applied to the barrier layer at a basis weight of 1.0 to 2.0 grams per square meter.

In yet another approach, the non-paper layer(s) of the liner consists of a layer of polyvinylidene chloride (PVDC) adhered to an inner surface of the paper layer and having a basis weight of 12 to 18 grams per square meter. The layer of PVDC provides both barrier and sealing characteristics to the liner. The paper layer of the liner has a basis weight of 35 to 45 grams per square meter.

In a still further approach, the non-paper layer(s) of the liner consist of a layer of polyvinylidene chloride (PVDC) having a basis weight of 8 to 12 grams per square meter and adhered to an inner surface of the paper layer, and a polyolefin film adhered to an inner surface of the layer of PVDC and having a basis weight of 10 to 15 grams per square meter. The paper layer of the liner has a basis weight of 35 to 45 grams per square meter.

The composite container can include an outer label wrapped about and adhered to the outer surface of the paperboard body ply. Preferably, the label is adhered in a manner allowing the label to be removed and recycled in a separate waste stream from the rest of the container. Accordingly, the label can be non-paper without impacting the recyclability of the container.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a perspective view of an easy-open container provided according to one preferred embodiment of the invention;

FIG. 2 is a perspective view of the easy-open container of FIG. 1, illustrating removal of the portion of the outer label covering the easy-open joint;

FIG. 3 is a greatly enlarged fragmentary sectional view taken along line 3-3 of FIG. 1;

FIG. 4 is a greatly enlarged fragmentary sectional view showing details of the liner of the container, in accordance with one embodiment of the invention;

FIG. 5 is a greatly enlarged fragmentary sectional view showing details of the liner of the container, in accordance with another embodiment of the invention;

FIG. 6 is a greatly enlarged fragmentary sectional view showing details of the liner of the container, in accordance with yet another embodiment of the invention;

FIG. 7 is a greatly enlarged fragmentary sectional view showing details of the liner of the container, in accordance with a still further embodiment of the invention; and

FIG. 8 is a greatly enlarged fragmentary sectional view showing details of the liner of the container, in accordance with a still further embodiment of the invention.

### DETAILED DESCRIPTION OF THE DRAWINGS

The present inventions now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

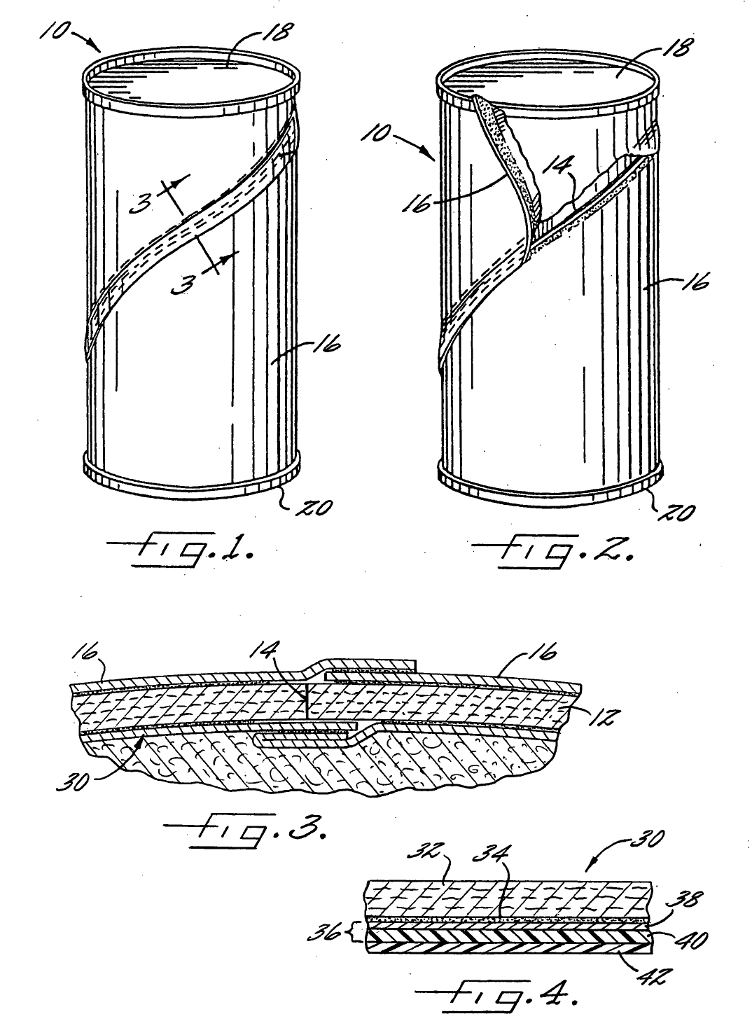

FIGS. 1 and 2 illustrate one embodiment of an easy-open container 10 provided according to the invention, and FIG. 3 is a cross-sectional view through a portion of the container wall. The container 10 is of substantially cylindrical form. The primary structural member of the container is a paperboard body ply 12 that is helically wound about an axis to form a tubular container body. Opposite edges of the body ply 12 are abutted (either to form a butt joint as shown in FIG. 3 or to form an overlap joint, not shown) but are unattached to each other so as to form a separable or “easy-open” joint 14 that extends helically along the container body. A helically wound outer label 16 is wound about the outer surface of the body ply 12 and is adhered thereto with a suitable adhesive that allows the label (or at least a portion thereof) to be peeled away from the body ply when it is desired to open the container. The label serves the important function (in addition to providing a suitable surface for printing of text and graphics describing the contained product) of keeping the joint 14 from prematurely separating during shipping and storage of the container. The label 16 can be constructed of any of various flexible sheet materials such as paper (e.g., kraft), plastic film, film/foil laminates, paper/foil laminates, paper/film laminates, and the like. A top end closure 18 and a bottom end closure 20 are provided on the opposed ends of the container.

The body ply 12 is advantageously composed of a conventional paperboard or boardstock composed of kraft or recycled paper and having a basis weight of about 450 to 500 grams per square meter (gsm). Boardstock conventionally used in the manufacture of spiral wound containers is commercially available from various manufacturers including Sonoco Products Corporation. In some instances, the boardstock can include a weak exterior layer, for example, a 0.003 inch thick exterior news layer.

A liner ply 30 is adhered to the inner surface of the paperboard body ply 12. The liner ply is a barrier-type, flexible sheet material formed as a laminate that includes a paper layer (e.g., a kraft layer) and at least one non-paper layer imparting barrier and sealing characteristics to the liner. The liner ply prevents the transmission of liquids, oils, and gases into or out of the container wall. The paper layer of the liner ply is adhered directly to the inner surface of the body ply 12 using a suitable adhesive.

As noted, an objective of the present invention was to reduce the weight of the non-paper components of the liner 30 such that the non-paper materials do not exceed 5% of the combined weight of the body ply 12 and liner ply 30. In a typical conventional dough can, the non-paper materials (typically including an aluminum foil layer serving as a barrier layer and a polymer layer serving as a sealant layer) constitute about 8% of the combined weight. Thus, to meet the objective, it was required to reduce the weight of the non-paper materials by about 38%, while not compromising any of the aforementioned functions required of the liner ply.

A liner ply construction that achieves this objective, in accordance with one embodiment of the invention, is shown in FIG. 4. The liner ply 30 includes a paper layer 32 (e.g., a kraft layer) having a basis weight of 30 to 35 gsm. An adhesive layer 34 is applied to an inner surface of the paper layer such that the adhesive layer has a basis weight of 1.0 to 2.0 gsm. A barrier layer in the form of a metallized polymer film 36 is adhered via the adhesive layer 34 to the inner surface of the paper layer 32. The metallized film 36 comprises a polymer film 40 having one surface coated with a sub-micron thick layer 38 of a substantially pure metal (e.g., aluminum) in non-oxide form. The polymer film 40 can be an oriented polypropylene (OPP) film. The metal layer 38 can be deposited by a vacuum deposition process as known in the art. The metallized film 36 preferably has a total thickness of 8 to 15 μm, and more preferably 10 to 12 μm. The liner ply further includes a layer 42 of a polyolefin such as polyethylene as a sealant layer that forms the innermost surface of the liner. The sealant layer 42 gives the liner ply the ability to seal to itself to form an overlap joint between opposite edges of the liner ply as shown in FIG. 3. The sealant layer 42 has a basis weight of 8 to 12 gsm.

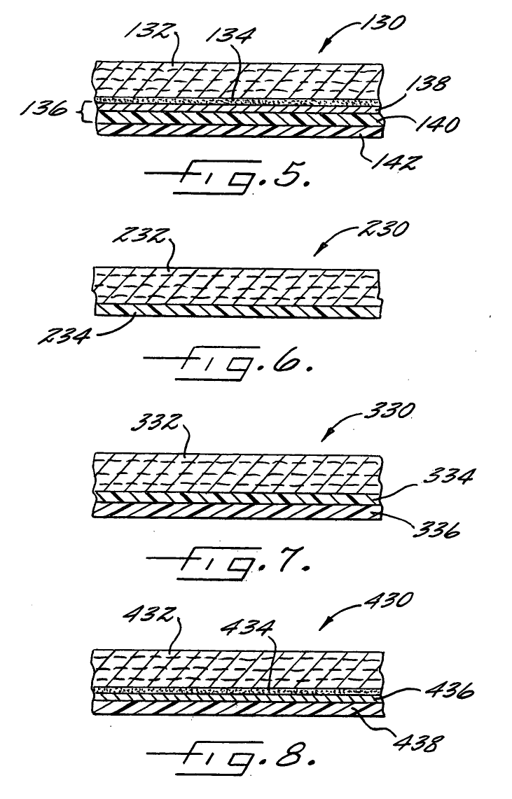

A liner ply 130 in accordance with a second embodiment is shown in FIG. 5. The liner ply 130 includes a paper layer 132 (e.g., a kraft layer) having a basis weight of 35 to 45 gsm. An adhesive layer 134 is applied to an inner surface of the paper layer such that the adhesive layer has a basis weight of 1.0 to 2.0 gsm. A metallized polymer film 136 is adhered via the adhesive layer 134 to the inner surface of the paper layer 132. The metallized film comprises a polymer film 140 having one surface coated with a sub-micron thick layer 138 of a substantially pure metal (e.g., aluminum) in non-oxide form. The polymer film 140 can be a polyethylene terephthalate (PET) film. The metal layer 138 is deposited by a vacuum deposition process as known in the art. The metallized film 136 preferably has a thickness of 8 to 15 μm, and more preferably 10 to 12 μm. The liner ply further includes a layer 142 of a sealing varnish that forms the innermost surface of the liner. The sealing varnish 142 gives the liner ply the ability to seal to itself to form an overlap joint between opposite edges of the liner ply as shown in FIG. 3. The sealing varnish 142 has a basis weight of 1.0 to 2.0 gsm.

A liner ply 230 in accordance with a third embodiment is illustrated in FIG. 6. The liner ply 230 includes a paper layer 232 (e.g., a kraft layer) having a basis weight of 35 to 45 gsm. A barrier/sealant layer 234 of extrusion-coated polyvinylidene chloride (PVDC) is disposed on the inner surface of the paper layer. The PVDC layer is extrusion-coated onto the paper layer at a basis weight of 12 to 18 gsm, more preferably 14 to 16 gsm.

A liner ply 330 in accordance with a fourth embodiment is shown in FIG. 7. The liner ply 330 includes a paper layer 332 (e.g., a kraft layer) having a basis weight of 35 to 45 gsm. A barrier layer 334 of extrusion-coated polyvinylidene chloride (PVDC) is disposed on the inner surface of the paper layer. The PVDC layer is extrusion-coated onto the paper layer at a basis weight of 8 to 12 gsm, more preferably 9 to 11 gsm. The liner ply further includes a sealant layer 336 of a polyolefin (e.g., polyethylene) disposed on the inner surface of the PVDC layer. The sealant layer has a basis weight of 10 to 15 gsm.

A liner ply 430 in accordance with a fifth embodiment is shown in FIG. 8. the liner ply 430 includes a paper layer 432 (e.g., a kraft layer) having a basis weight of 35 to 45 gsm. An adhesive layer 434 is applied to an inner surface of the paper layer with a basis weight of 1.0 to 2.0 gsm. A metal foil (e.g., aluminum foil) layer 436 is adhered to the paper layer via the adhesive layer 434. The foil layer has a thickness of 5 to 10 μm, with 7 μm being a particularly suitable thickness. A sealant layer 438 of sealing varnish is applied to the inner surface of the foil layer, at a basis weight of 1.0 to 2.0 gsm.

Thus, as a general proposition, the invention in one aspect entails selecting the basis weights of the body ply 12, the paper layer (32, 132, 232, 332, 432) of the liner, and the non-paper layers of the liner, such that the total weight of the paper material, (BP+PL), divided by the total weight of all materials, (BP+PL+NP), is at least 0.95, where BP is the weight of the body ply, PL is the weight of the paper layer of the liner, and NP is the weight of the non-paper layer(s) of the liner. With any of the above-described liner ply structures, or variations thereof that would be apparent to those skilled in the art, the weight of the non-paper materials in the container (body ply and liner ply) is no more than 5% of the combined body ply plus liner ply weight, when the liners are combined with a body ply 12 having a basis weight of 450 to 500 gsm.

The liner structures described above also have satisfactory barrier properties. In particular, it is generally desirable for the liner ply to have a moisture vapor transmission rate (MVTR) of not more than 0.2 g/100 in²/day and an oxygen transmission rate (OTR) of not more than 0.2 cc/100 in²/day, more preferably an MVTR of not more than 0.1 g/100 in²/day and an OTR of not more than 0.1 cc/100 in²/day.

In use of composite containers made in accordance with the above description, once the containers have served their original purpose and have been emptied of their contents, the containers can be recycled. Advantageously, in many recycling jurisdictions, the containers can be treated as all-paper articles because they contain less than 5% by weight of non-paper materials. When the label 16 comprises paper, the label can be left on the container, if it has not already been removed during the process of opening the container. If the label comprises more than a negligible amount of non-paper material, then the label (or at least a majority thereof) can be removed prior to recycling the container, if necessary. The label can be recycled in a separate waste stream.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A composite container for refrigerated dough, comprising:
a paperboard body ply wrapped helically about an axis to form a tubular container body, with opposite edges of the paperboard body ply being abutted but unattached so as to form a separable joint that extends helically about the container body, the container body having an inner surface formed by one side of the paperboard body ply and an outer surface formed by an opposite side of the paperboard body ply, the paperboard body ply having a weight of BP; and
a liner adhered to the inner surface of the container body, the liner being formed by a liner ply wound helically about the axis with opposite edges of the liner ply being overlapped and attached to each other, the liner ply consisting of a paper layer having an outer surface adhered to the inner surface of the container body, the paper layer having a weight of PL, and at least one non-paper layer imparting moisture/gas barrier and sealing characteristics to the liner, the non-paper layer(s) having a total weight of NP;
wherein the weights of the paperboard body ply and the paper and non-paper layers of the liner are selected such that (BP+PL) divided by (BP+PL+NP) is at least 0.95.

2. The composite container of claim 1, wherein the non-paper layer(s) of the liner consists of:
an adhesive layer applied to an inner surface of the paper layer and having a weight of AL;
a barrier layer having an outer surface adhered to the adhesive layer, the barrier layer having a weight of BL; and
a sealant layer adhered to an inner surface of the barrier layer and having a weight of SL;
wherein the weights of the paperboard body ply and the layers of the liner are selected such that (BP+PL) divided by (BP+PL+AL+BL+SL) is at least 0.95.

3. The composite container of claim 2, wherein the barrier layer is a polymer film one surface of which is metallized with a vacuum-deposited coating of a substantially pure metal in non-oxide form, the barrier layer having a thickness of about 10 to 12 μm.

4. The composite container of claim 3, wherein the polymer film of the barrier layer is oriented polypropylene.

5. The composite container of claim 4, wherein the sealant layer is a polyolefin film having a thickness of about 10 to 15 μm.

6. The composite container of claim 5, wherein the paper layer of the liner has a basis weight of 30 to 35 grams per square meter.

7. The composite container of claim 5, wherein the sealant layer is a polyethylene film.

8. The composite container of claim 3, wherein the polymer film of the barrier layer is polyethylene terephthalate.

9. The composite container of claim 8, wherein the sealant layer is a sealing varnish applied to the barrier layer at a basis weight of 1.0 to 2.0 grams per square meter.

10. The composite container of claim 2, wherein the barrier layer is a layer of metal foil having a thickness of 5 to 10 μm.

11. The composite container of claim 10, wherein the sealant layer is a sealing varnish applied to the barrier layer at a basis weight of 1.0 to 2.0 grams per square meter.

12. The composite container of claim 1, wherein the non-paper layer(s) of the liner consists of a layer of polyvinylidene chloride (PVDC) adhered to an inner surface of the paper layer and having a basis weight of 12 to 18 grams per square meter, the layer of PVDC providing both barrier and sealing characteristics to the liner.

13. The composite container of claim 12, wherein the paper layer of the liner has a basis weight of 35 to 45 grams per square meter.

14. The composite container of claim 1, wherein the non-paper layer(s) of the liner consist of a layer of polyvinylidene chloride (PVDC) having a basis weight of 8 to 12 grams per square meter and adhered to an inner surface of the paper layer, and a polyolefin film adhered to an inner surface of the layer of PVDC and having a basis weight of 10 to 15 grams per square meter.

15. The composite container of claim 14, wherein the paper layer of the liner has a basis weight of 35 to 45 grams per square meter.

16. The composite container of claim 1, wherein the paperboard body ply is a single layer of paperboard having a basis weight of 450 to 500 grams per square meter, the paper layer of the liner has a basis weight of 30 to 45 grams per square meter, and the non-paper layer(s) of the liner has/have a total basis weight of 12 to 35 grams per square meter.

17. The composite container of claim 1, wherein the liner has a moisture vapor transmission rate not more than 0.2 g/100 in²/day and an oxygen transmission rate not more than 0.2 cc/100 in²/day.
